(19) United States
(12) Patent Application Publication
(10) Pub. No.: US 2017/0205507 A1
(43) Pub. Date: Jul. 20, 2017

(54) OBJECT DETECTING DEVICE AND METHOD

(71) Applicant: Panasonic Corporation, Osaka (JP)

(72) Inventors: Weijie LIU, Kanagawa (JP); Yoichi NAKAGAWA, Tokyo (JP)

(21) Appl. No.: 15/388,218

(22) Filed: Dec. 22, 2016

(30) Foreign Application Priority Data
Jan. 15, 2016 (JP) 2016-006073

(51) Int. Cl. G01S 13/93; G01S 13/62; G01S 13/42; G01S 13/87

(52) U.S. Cl. CPC G01S 13/931; G01S 13/87; G01S 13/62; G01S 13/42; G01S 2013/9332

(57) ABSTRACT

An object detecting device includes the following elements. Pair formation circuitry forms one or more pairs of each of the one or more first group and an associated second group selected as one or more pairing target groups by selecting from among the one or more second groups. Object region calculation circuitry calculates, on the coordinate system, one or more target object regions for each of the one or more pairs. Object recognition circuitry recognizes, on the coordinate system, each of the one or more target objects based on each of the one or more target object regions.

### BACKGROUND

1. Technical Field

The present disclosure relates to an object detecting device and method, and more specifically, to an object detecting device which is used in a road infrastructure system and detects correct positions and velocities of objects existing on or around the road, and also to an object detecting method.

2. Description of the Related Art

Nowadays, the use of an object detecting device in a road infrastructure system is becoming widespread. In the road infrastructure system, an object detecting device is installed on or around the road and detects objects (such as four-wheeled vehicles, two-wheeled vehicles, and pedestrians) by using radar. Then, based on the positions and velocities of the objects detected by the object detecting device, the road infrastructure system conducts the monitoring of the traffic situation and traffic management.

More specifically, as the monitoring of the traffic situation, the road infrastructure system detects the traffic volume, speeding, and ignoring of traffic signals, for example. As the traffic management, the road infrastructure system controls traffic signals based on the detected traffic volume, for example, or detects an object in a blind spot for a vehicle and informs the driver of the existence of the detected object.

In this manner, in the road infrastructure system equipped with the object detecting device, the streamlining of the traffic flow and traffic accident prevention is implemented.

It is desirable that the object detecting device used in the road infrastructure system reduce blind spots and detect objects with high precision by using measurement information obtained from plural radar devices installed at different locations.

Japanese Unexamined Patent Application Publication No. 2009-41981 discloses an object detecting device that specifies one point on an object by using measurement information obtained from plural radar devices and detects the traveling direction and velocity of the object on the basis of the specified point. This object detecting device includes plural transmit antennas and plural receive antennas located at different positions, and detects the position and the Doppler velocity of an object based on each of the transmit antennas and each of the receive antennas so as to calculate the traveling velocity of the object.

### SUMMARY

However, the above-described object detecting device calculates the traveling velocity of an object on the basis of one point on the object, and is not able to sufficiently detect the region of the entire object. More specifically, the object detecting device determines the traveling velocity of the entire object on the basis of the value of only one point on the object. Accordingly, the calculated value of the traveling velocity considerably differs according to which point on the object is measured. Even if the object detecting device calculates different traveling velocities on the basis of plural adjacent points on the object, it is still unknown which traveling velocity corresponds to the traveling velocity of the entire object, thereby making it difficult to calculate the correct traveling velocity of the entire object.

One non-limiting and exemplary embodiment provides an object detecting device and method in which the region of the entire object can be defined from values measured by radar devices.

In one general aspect, the techniques disclosed here feature an object detecting device including first acquisition region extraction circuitry, which in operation, extracts one or more first acquisition regions from among a plurality of first unit regions corresponding to a first radar device, each of one or more target objects being likely to be located in each of the one or more first acquisition regions; second acquisition region extraction circuitry, which in operation, extracts one or more second acquisition regions from among a plurality of second unit regions corresponding to a second radar device, each of the one or more target objects being likely to be located in each of the one or more second acquisition regions; first group formation circuitry, which in operation, forms one or more first groups each including each of the one or more first acquisition regions; second group formation circuitry, which in operation, forms one or more second groups each including each of the one or more second acquisition regions; pair formation circuitry, which in operation, forms one or more pairs of each of the one or more first group and an associated second group selected as one or more pairing target groups by selecting from among the one or more second groups, on a coordinate system including the one or more first groups, the one or more second groups, and the first and second radar devices, on the basis of a position of the first radar device, a position of the second radar device, and a size of a corresponding first group of the one or more first groups; object region calculation circuitry, which in operation, calculates, on the coordinate system, one or more target object regions for each of the one or more pairs; and object recognition circuitry, which in operation, recognizes, on the coordinate system, each of the one or more target objects based on each of the one or more target object regions.

According to an aspect of the present disclosure, it is possible to define the region of the entire object on the basis of values measured by radar devices.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates an example of a road infrastructure system according to an embodiment of the present disclosure;

FIG. 2 is a block diagram illustrating the major configuration of an object detecting device according to a first embodiment and the connection relationship of the object detecting device to two radar devices and a monitoring system;

FIG. 3 illustrates a power profile as an example of measurement information;

FIG. 4 illustrates a Doppler velocity profile as an example of measurement information;

FIG. 5 illustrates examples of groups of acquisition regions according to the first embodiment;

FIGS. 6 and 7 illustrate an example of pairing processing according to the first embodiment;

FIG. 8 illustrates an example of calculation processing for an object region according to the first embodiment;

FIG. 9 illustrates another example of the installation positions of two radar devices according to a modified example of the first embodiment;

FIG. 10 is a block diagram illustrating the major configuration of an object detecting device according to a second embodiment and the connection relationship of the object detecting device to two radar devices and a monitoring system;

FIG. 11 is a block diagram illustrating the major configuration of an object detecting device according to a third embodiment and the connection relationship of the object detecting device to two radar devices and a monitoring system;

FIGS. 12A and 12B illustrate examples of location-point models according to the third embodiment;

FIG. 13 is a block diagram illustrating the major configuration of an object detecting device according to a fourth embodiment and the connection relationship of the object detecting device to two radar devices and a monitoring system;

FIG. 14 is a diagram for explaining the measured distance in accordance with the height of a target object according to the fourth embodiment;

FIG. 15A illustrates an example of the position of a target object region when the set height is 0 according to the fourth embodiment;

FIG. 15B illustrates an example of the position of a target object region when the set height is h1 (>0) according to the fourth embodiment;

FIG. 15C illustrates an example of the position of a target object region when the set height is h2 (>h1) according to the fourth embodiment; and

FIG. 15D illustrates an example of the position of a target object region when the set height is h3 (>h2) according to the fourth embodiment.

### DETAILED DESCRIPTION

### (Underlying Knowledge Forming Basis of the Present Disclosure)

The underlying knowledge forming the basis of the present disclosure will first be described. The present disclosure relates to an object detecting device for use in a road infrastructure system.

An object detecting device for use in a road infrastructure system is installed on or around the road and detects objects (such as four-wheeled vehicles, two-wheeled vehicles, and pedestrians) by using radar.

Unlike optical sensors such as cameras, radar can be used during the night as well as during the daytime and exhibit high resistance to unfavorable weather conditions such as rain and fog. On the other hand, however, a higher capability to identify objects is demanded for an object detecting device installed on or around the road than for an object detecting device installed in a vehicle.

One of the reasons for this is that there are many and a great variety of objects on or around the road. For example, at an intersection, many objects, such as vehicles, motorcycles, bicycles, and pedestrians, traveling in different directions approach and cross each other. Measurement results for plural objects are different from those for a single object, which makes it difficult for radar to define the region of an object and to determine what type the object is. For this reason, a high object identifying capability is demanded for an object detecting device installed on or around the road.

Another reason is that, on or around the road, the Doppler velocity measured by radar is not distinctive as a feature for identifying an object. The Doppler velocity is a velocity in a range of the radial direction around radar. Accordingly, a variation in the Doppler velocity measured by radar of the object detecting device installed on or around the road is greater than that by radar of the object detecting device installed in a vehicle. Depending on the situation, on or around the road, the traveling direction of an object may be the same as the direction of a tangent line perpendicular to the radial direction around radar, which may make it difficult for radar to measure the Doppler velocity of the object. For this reason, too, a high object identifying capability is demanded for an object detecting device installed on or around the road.

If the object detecting device installed on or around the road has a high object identifying capability, it can individually identify objects having different features so that it can precisely detect the traffic volume and estimate the possibility of a collision. Conversely, if the object detecting device does not have a high object identifying capability, it is not able to individually identify objects having different features with high precision. For example, the object detecting device may omit detecting some objects or incorrectly detect the types of objects. This makes it difficult for the object detecting device to precisely detect the traffic volume and to precisely estimate the possibility of a collision.

For reducing blind spots, the road infrastructure system includes plural radar devices located at different locations. The object detecting device integrates items of measurement information from the plural radar devices installed on or around the road and detects objects within a target area.

The object detecting device disclosed in Japanese Unexamined Patent Application Publication No. 2009-41981 is an example of the related art which detects objects by integrating items of measurement information from plural radar devices. This object detecting device assumes the values measured for an object by the radar devices as the values measured for the same position in a space, and calculates the moving velocity of the object, based on the positional relationship between the same position in a space and the position of each of the radar devices and on the Doppler velocity measured by each of the radar devices.

The values measured by the radar devices of this object detecting device are likely to represent positions on the same side of a leading vehicle. Accordingly, this object detecting device is effective for calculating the moving velocity of a leading vehicle by using radar devices installed in a subject vehicle. However, if object detection is performed by using plural radar devices installed on or around the road, it is difficult for the radar devices to measure the value of the same position of an object, unlike the radar devices of the above-described object detecting device. For example, if the position of a single vehicle is measured by using two radar devices installed at diagonal positions of an intersection, the values measured by the plural radar devices are likely to represent positions on different sides of this vehicle. Accordingly, if the values measured by the radar devices represent positions on different sides of an object, the above-described object detecting device may not be able to detect this object. It is thus difficult to apply this object detecting device to a road infrastructure system.

Additionally, since this object detecting device calculates the moving velocity of an object on the basis of one point on the object, it may not be able to calculate the range of the object region. Accordingly, it is difficult to use this object detecting device for calculating the moving velocity of an object on the basis of plural points on this object. That is, if the moving velocities calculated based on plural points on the object are different, it is difficult for this object detecting device to determine the correct moving velocity of the object.

If an object detecting device detects an object by using plural radar devices installed on or around the road, the values measured by the radar devices represent positions on different sides of this object. Since the values measured by the radar devices are different, the object detecting device is required to calculate the region of the object by using these different values.

In view of the above-described circumstances, the present disclosure has been made by giving special attention to the calculating of the region of an object by using different values measured by radar devices.

According to an aspect of the present disclosure, it is possible to provide an object detecting device and method in which the region of the entire object can be defined from values measured by radar devices. By using the object detecting device and method, the positions and velocities of objects, such as four-wheeled vehicles, two-wheeled vehicles, and pedestrians, on or around the road can be correctly detected, thereby making it possible to provide information necessary for a traffic monitoring and management system.

### (Image of the Application of the Present Disclosure)

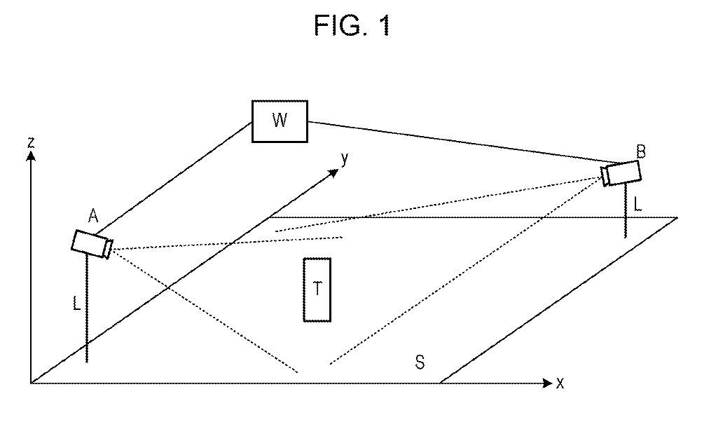

FIG. 1 illustrates the configuration of a road infrastructure system including an object detecting device according to an embodiment and radar devices. In FIG. 1, the horizontal axis (x axis) indicates the horizontal direction, while the vertical axis (z axis) indicates the height direction.

In FIG. 1, radar devices A and B are each supported by a support device L, such as a pole. The radar devices A and B each include a transmitter, a receiver, and a signal processor (none of which are shown). The transmitter sequentially transmits radar signals by changing the direction at a predetermined interval of the angle. The receiver receives a reflection signal generated as a result of a transmitted radar signal being reflected by a target object. The signal processor converts the reflection signal into a baseband signal and obtains a delay profile (propagation delay characteristic) for every transmitting direction of a radar signal. The radar devices A and B may use the same signal processor.

In FIG. 1, an object detecting device W is connected to the radar devices A and B and receives measurement information from each of the radar devices A and B. The transmission method from the radar devices A and B to the object detecting device W is not particularly restricted, and either one of a wired communication method or a wireless communication method may be used.

In FIG. 1, a road surface S may be the surface of a straight road or part of an intersection.

In FIG. 1, a target object T is, for example, a vehicle, a motorcycle, a bicycle, or a pedestrian.

The radar devices A and B may be installed at positions above the road, on the roadside, above the intersection, or at the corners of the intersection. In the present disclosure, the installation positions of the radar devices A and B and how to install, them are not restricted as long as target objects (such as vehicles, motorcycles, bicycles, and pedestrians) on and around a crosswalk at the intersection are included in detection ranges of the radar devices A and B.

In the present disclosure, the positional relationship between the detection ranges of the radar devices A and B is not restricted, either. However, the present disclosure is applied to a superposing range of the detection range of the radar device A and the detection range of the radar device B. Accordingly, it is preferable that at least one target object be included in the superposing range of the radar devices A and B.

In the present disclosure, the configuration of the radar devices A and B is not restricted, either. The radar devices A and B may be existing commercial products or products formed by using the related art.

Although in FIG. 1 the object detecting device W is provided separately from the radar devices A and B, it may be included in the radar device A or B.

Embodiments of the present disclosure will be described below in detail with reference to the accompanying drawings. It is to be understood that the following embodiments are only examples and the present disclosure is not limited to the embodiments.

### First Embodiment

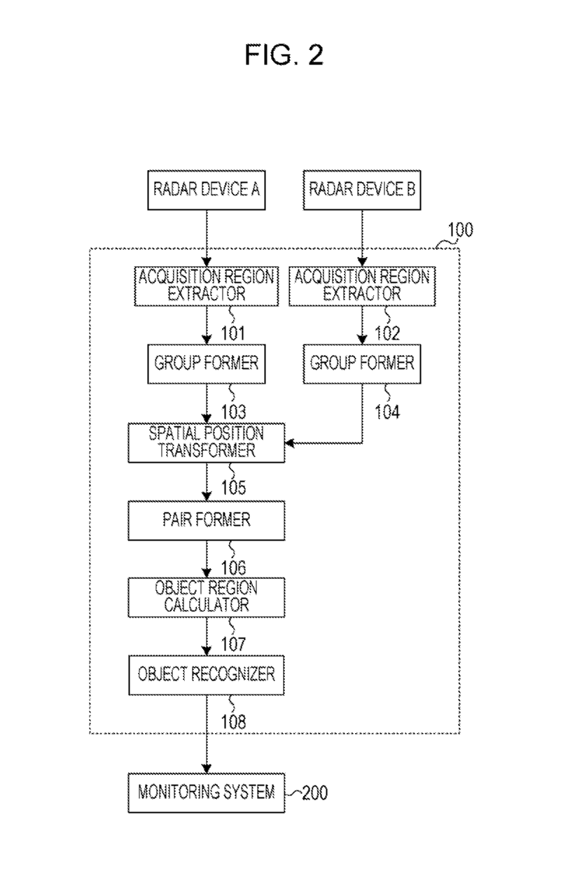

An object detecting device 100 according to a first embodiment will be described below with reference to the drawings. FIG. 2 is a block diagram illustrating the major configuration of the object detecting device 100 and the connection relationship of the object detecting device 100 to each of radar devices A and B and a monitoring system 200.

The object detecting device 100 is connected to the radar devices A and B and detects a target object by using the radar devices A and B.

The monitoring system 200 obtains information concerning the position or the velocity of an object detected by the object detecting device 100 and monitors the traffic situation (such as the traffic volume, speeding, and ignoring of traffic signals). The monitoring system 200 may also perform traffic management, for example, it may control traffic signals based on the detected traffic volume or may detect an object in a blind spot for a vehicle and inform the driver of the existence of the detected object.

The configuration of the object detecting device 100 and the operations of the elements forming the object detecting device 100 will be discussed below in detail.

As shown in FIG. 2, the object detecting device 100 includes an acquisition region extractors 101 and 102, group formers 103 and 104, a spatial position transformer 105, a pair former 106, an object region calculator 107, and an object recognizer 108. These elements forming the object detecting device 100 may be implemented by hardware such as a large scale integrated (LSI) circuit.

The acquisition region extractor 101 obtains measurement information from the radar device A. The acquisition region extractor 102 obtains measurement information from the radar device B. The measurement information obtained from each of the radar devices A and B includes at least one of power profile information and Doppler profile information.

Examples of the power profile information and the Doppler profile information will be discussed below.

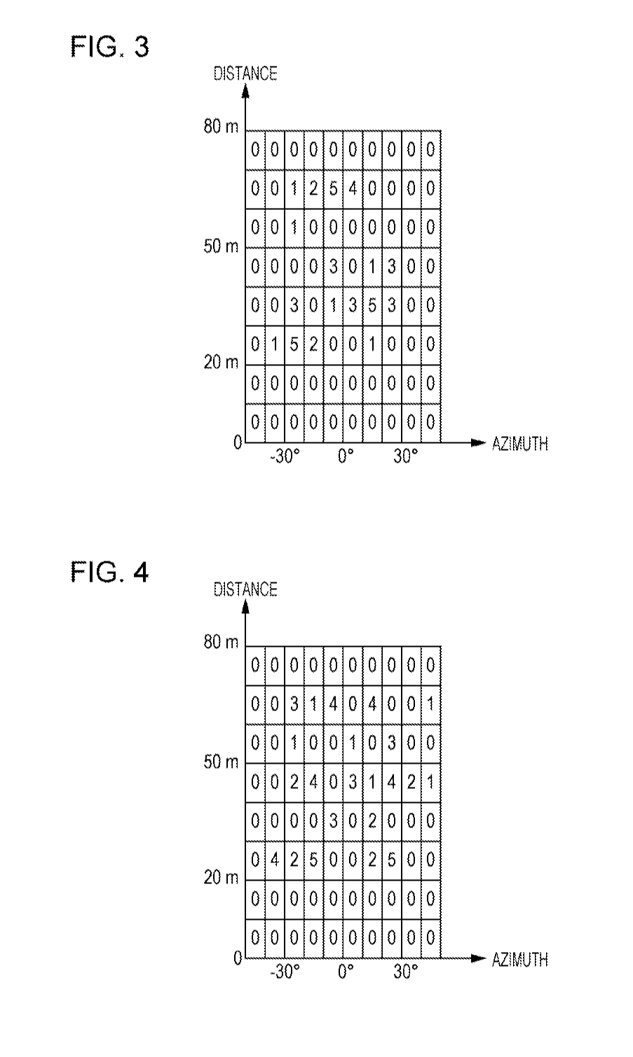

The power profile information as an example of the measurement information will first be discussed below with reference to FIG. 3. In FIG. 3, the horizontal axis indicates the azimuth based on the radar device A or B, while the vertical axis indicates the distance based on the radar device A or B. In FIG. 3, by dividing the azimuth on the horizontal axis in increments of 10° and by dividing the distance on the vertical axis in increments of 10 m, unit regions (hereinafter referred to as “spatial cells” or simply “cells”) are formed. Each spatial cell represents spatial resolution.

In FIG. 3, the reflection intensity in each cell is represented by one of the six levels from 0 to 5. The level 5 indicates the highest reflection intensity. For the sake of simple representation, the values of the spatial cells other than specific ones are assumed as 0.

In the present disclosure, the reflection intensity in each spatial cell is the maximum value of received power within the spatial cell. Alternatively, as the reflection intensity within each spatial cell, another value, such as the average value, of received power within the spatial cell may be used.

The Doppler profile information as an example of the measurement information will now be discussed below with reference to FIG. 4. In FIG. 4, the horizontal axis indicates the azimuth based on the radar device A or B, while the vertical axis indicates the distance based on the radar device A or B. In FIG. 4, by dividing the azimuth on the horizontal axis in increments of 10° and by dividing the distance on the vertical axis in increments of 10 m, spatial cells are formed. Each spatial cell shown in FIG. 4 corresponds to an associated spatial cell forming the power profile information shown in FIG. 3.

In FIG. 4, the Doppler value in each cell is represented by one of the six levels from 0 to 5. The level 5 indicates the highest Doppler value. For the sake of simple representation, the values of the spatial cells other than specific ones are assumed as 0. The polarity (positive or negative) of the Doppler value changes in accordance with whether an object is approaching or separating from the radar device A or B. However, for the sake of simple representation, the positive Doppler values are shown in FIG. 4.

Examples of the power profile information and the Doppler profile information have been discussed. In the present disclosure, the range of the azimuth and the range of the distance of each spatial cell are not restricted to those shown in FIGS. 3 and 4. For obtaining higher resolution, the ranges of the azimuth and the distance of each spatial cell are preferably smaller. In the following description, each of the spatial cells shown in FIGS. 3 and 4 is handled as one point according to the necessity.

Based on the measurement information (power profile or Doppler profile information) output from the radar device A, the acquisition region extractor 101 extracts, as one or more acquisition regions for acquiring an object, one or more spatial cells in which a target object is likely to be located (that is, one or more spatial cells which are likely to be reflected from the target object) from among the plural spatial cells corresponding to the radar device A.

For example, by using a known image processing technique, the acquisition region extractor 101 extracts the local maximum values and the vicinities thereof on the power profile or the Doppler profile as acquisition regions. The number of spatial cells forming each acquisition region may not necessary be the same. The acquisition region extractor 101 may integrate the results of extracting acquisition regions based on the power profile information and the results of extracting acquisition regions based on the Doppler profile information. In this case, the acquisition region extractor 101 may integrate the extracting results by performing AND, OR or another operation calculation.

In a manner similar to the acquisition region extractor 101, based on the measurement information output from the radar device B, the acquisition region extractor 102 extracts, as one or more acquisition regions for acquiring an object, one or more spatial cells in which a target object is likely to be located from among the plural spatial cells corresponding to the radar device B.

The group former 103 groups one or more acquisition regions extracted by the acquisition region extractor 101 together. More specifically, the group former 103 forms plural acquisition regions which are likely to belong to the same object into one group. That is, the group former 103 forms plural groups each including at least one acquisition region. In this case, the group former 103 may form plural groups by considering, not only the spatial distance between acquisition regions, but also the similarity in the reflection intensity of power and that in the Doppler velocity.

In a manner similar to the group former 103, the group former 104 groups one or more acquisition regions extracted by the acquisition region extractor 102 together.

Groups formed by the group formers 103 and 104 may be referred to as “clusters”. Grouping of acquisition regions may be performed by using a known clustering technique in radar signal processing.

The spatial position transformer 105 performs coordinate transformation based on the installation positions of the radar devices A and B so as to unify the spatial coordinates of the radar device A and those of the radar device B. That is, the spatial position transformer 105 sets the same reference coordinate values for the radar devices A and B. The spatial position transformer 105 may utilize any one of the coordinate system of the radar device A, that of the radar device B, another third coordinate system, as the reference coordinates. As a result of coordinate transformation performed by the spatial position transformer 105, the groups of acquisition regions based on the spatial coordinates of the radar device A, the groups of acquisition regions based on the spatial coordinates of the radar device B, and the radar devices A and B are expressed by the same coordinate system. The elements subsequent to the spatial position transformer 105 perform processing based on the reference coordinates (the same coordinate system).

Among the groups formed by the group formers 103 and 104, the pair former 106 pairs a group formed by the group former 103 and a group formed by the group former 104 corresponding to the same object. For example, based on the reference coordinates set by the spatial position transformer 105, the pair former 106 pairs one of the plural groups formed by the group former 103 and one of the plural groups formed by the group former 104 corresponding to the same object in accordance with the range of the azimuth of each of the plural groups formed by the group former 103.

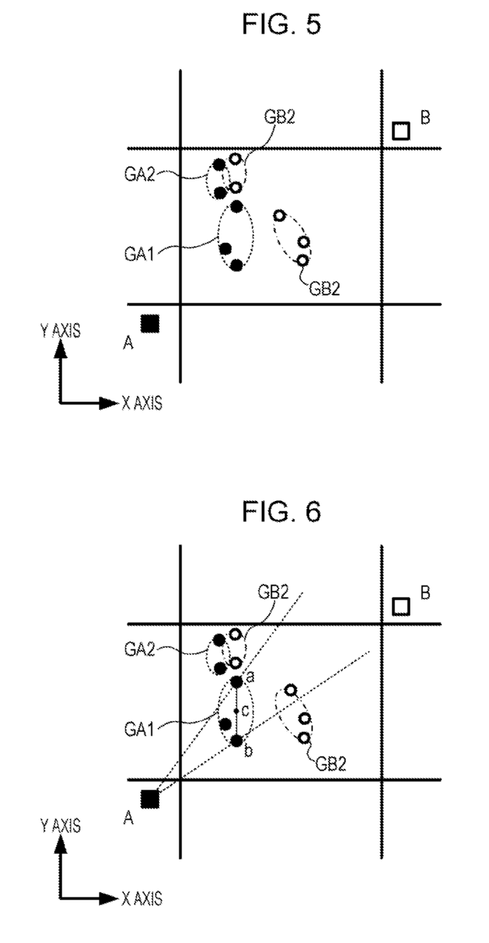

Pairing processing performed by the pair former 106 will be described below in detail with reference to FIGS. 5 through 7.

In FIG. 5, groups GA1 and GA2 (indicated by the dotted lines) including acquisition regions based on the spatial coordinates of the radar device A and groups GB1 and GB2 (indicated by the long dashed dotted lines) including acquisition regions based on the spatial coordinates of the radar device B are shown. The points within each group represent acquisition regions. The groups GA1 and GA2 are groups formed by the group former 103, while the groups GB1 and GB2 are groups formed by the group former 104.

A description will be given below, as an example, processing for searching for a group to be paired with the group GA1 from the groups GB1 and GB2 corresponding to the radar device B.

The pair former 106 first finds the range of the azimuth of the group GA1. For example, the pair former 106 may specify the range from the acquisition region at the leftmost edge to the acquisition region at the rightmost edge within the group GA1 as the range of the azimuth of the group GA1. In FIG. 6, for example, among the plural acquisition regions (plural points) within the group GA1, a point a indicates the acquisition region positioned at the leftmost azimuth based on the radar device A, while a point b indicates the acquisition region positioned at the rightmost azimuth based on the radar device A. The pair former 106 specifies the range from the point a to the point b (that is, a line segment ab) as the range of the azimuth of the group GA1. In FIG. 6, a point c is a midpoint of the line segment ab.

The pair former 106 may perform fitting on the plural acquisition regions within the group GA1 by using a specified configuration (for example, an ellipse), and then, may specify the leftmost edge and the rightmost edge of the configuration of the group GA1 as the point a and the point b, respectively.

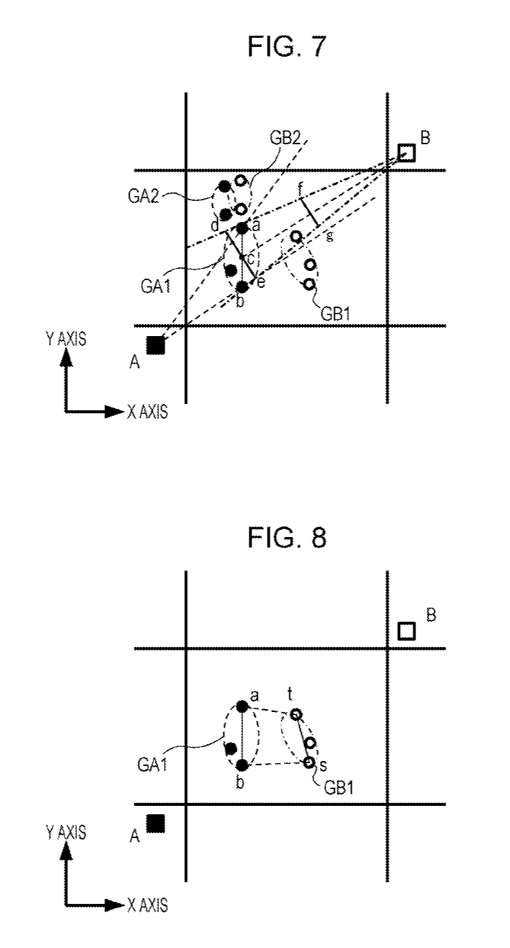

Then, in FIG. 7, the pair former 106 finds a line segment de passing through the point c and being perpendicular to a line segment cB (indicated by the dashed line) connecting the point c and the radar device B. In this case, the pair former 106 sets the point c as a midpoint of the line segment de and sets the length of the line segment de to be equal to or longer than the line segment ab. In other words, the pair former 106 calculates the positions of the edges d and e of the line segment de having the same midpoint (point c) as the line segment ab, being perpendicular to the line segment cB connecting the point c and the radar device B, and having a length equal to or longer than the length of the line segment ab.

Then, among a region dBe formed by connecting the positions of the points d and e and the position of the radar device B, the pair former 106 sets a region dfge which is within a predetermined distance from the line segment de toward the radar device B as a search region for a group to be paired with the group GA1.

The pair former 106 then sets a group of the radar device B which at least contacts the search region dfge as a group to be paired with the group GA1. That is, among plural groups corresponding to the radar device B, the pair former 106 selects a group including at least one acquisition region contained in the search region dfge as a group to be paired with the group GA1, and forms a pair of the selected group and the group GA1.

In FIG. 7, for example, the pair former 106 sets the group GB1 including one acquisition region contained in the search region dfge as a group to be paired with the group GA1. If there are plural groups of the radar device B which contact the search region dfge used for searching for a group to be paired with the group GA1, the pair former 106 may select a group to be paired with the group GA1 in the following manner. If the length of a line segment representing the range of the azimuth of a group (for example, the length of a line segment st, which will be discussed later) is equal to or greater than a predetermined threshold, such a group is set to be a candidate. Then, among the plural candidates, the group having the smallest distance from the line segment ab is selected as a group to be paired with the group GA1. For example, the distance between the midpoints of the line segments ab and st is the smallest, and thus, the group GB1 is selected as a group to be paired with the group GA1.

That is, on the reference coordinates, based on the position of a first radar device (radar device A), the position of a second radar device (radar device B), and the range (size) of each of first groups (groups GA1 and GA2 including acquisition regions based on the spatial coordinates of the radar device A), the pair former 106 selects one second group from among one or more second groups (groups GB1 and GB2 including acquisition regions based on the spatial coordinates of the radar device B) as a group to be paired with each of the first groups, thereby forming a pair of each of the first groups and an associated second group selected as a pairing target group.

The object region calculator 107 calculates the region of a target object, on the basis of groups paired by the pair former 106, that is, a group (first group) formed based on the values measured by the radar device A and a group (second group) formed based on the values measured by the radar device B. Calculation processing for the region of a target object performed by the object region calculator 107 will be described below with reference to FIG. 8. In FIG. 8, the line segment ab represents the range of the azimuth of the group GA1, while the line segment st represents the range of the azimuth of the group GB1 paired with the group GA1. The object region calculator 107 calculates a region abst as the region of the target object The object region calculator 107 may perform fitting on the region abst by using a specified configuration (for example, a parallelogram or an ellipse) and specify the resulting region as the object region.

The object recognizer 108 determines the position, size, configuration, and type (for example, large-size four-wheeled vehicle, small-size four-wheeled vehicle, two-wheeled vehicle, or pedestrian) of a target object T, based on feature information (such as the size, configuration, and reflection intensity) concerning the object region calculated by the object region calculator 107. Then, the object recognizer 108 outputs information concerning the recognition results to the outside of the object detecting device 108 (to the monitoring system 208).

In the first embodiment, the specific approach to recognizing an object by the object recognizer 108 is not restricted. For example, the object recognizer 108 may store a template model concerning the sizes and configurations of object regions according to the type of object, and may perform recognition processing by comparing information concerning the region of a target object output from the object region calculator 107 with the template model. Alternatively, the object recognizer 108 may perform recognition processing by using a template model concerning the distribution in the reflection intensity according to the type of object.

In FIGS. 5 through 8, processing based on the group GA1 has been discussed. The object detecting device 100 also performs processing based on another group (for example, group GA2) in a similar manner.

As described above, in the object detecting device 100 of the first embodiment, in accordance with the range of the azimuth of a subject group including acquisition regions formed by the group former 103, the pair former 106 calculates a region (search region) in which, among plural groups including acquisition regions formed by the group former 104, a group to be paired with the subject group may be included, and then forms a pair of the group included in the search region and the subject group.

In this manner, by using acquisition regions extracted based on the values measured by plural radar devices, the object detecting device 100 forms a pair of two groups corresponding to the same object. The region of a target object represented by such a paired group is difficult to calculate based on measurement information output from a single radar device.

According to the first embodiment, since an object region is calculated by using the values measured by plural radar devices located at different positions, the region of the entire object can be detected with high precision. As a result, the object detecting device 100 is able to detect the correct positions and velocities of four-wheeled vehicles, two-wheeled vehicles, and pedestrians on or around the road and thus to provide information necessary for the monitoring system 200 including a traffic monitoring or traffic management system.

### MODIFIED EXAMPLES

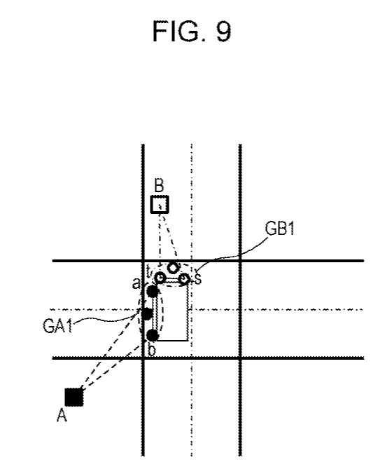

In the first embodiment, the radar devices A and B are installed at diagonal positions (see, for example, FIG. 5). However, the installation positions of the radar devices A and B are not restricted to diagonal positions. FIG. 9 illustrates another example of the installation positions of the radar devices A and B.

In FIG. 9, the line segment ab within the group GA1 represents the range of the azimuth of acquisition regions extracted based on the values measured by the radar device A, while the line segment st within the group GB1 represents the range of the azimuth of acquisition regions extracted based on the values measured by the radar device B. In FIG. 9, the object detecting device 100 defines the object region based on the region abst. In this case, however, the object detecting device 100 estimates that the line segments ab and st do not correspond to opposing sides of a target object, but to perpendicular sides of the target object.

If, on the reference coordinates, the angle at which a straight line extending from the line segment ab and a straight line extending from the line segment st intersect each other is substantially 0 degrees, that is, if the line segments ab and st are substantially parallel with each other (see, for example, FIG. 8), the object detecting device 100 estimates that the line segments ab and st of the region abst are constituted by opposing sides among plural sides of a target object. On the other hand, if the angle at which a straight line extending from the line segment ab and a straight line extending from the line segment st intersect each other is substantially 90 degrees (see, for example, FIG. 9), the object detecting device 100 estimates that the line segments ab and st of the region abst are constituted by perpendicular sides among plural sides of a target object.

In the first embodiment, the pair former 106 determines a search region with respect to the group GA of the radar device A. However, the pair former 106 may determine a search region with respect to the group GB of the radar device B, and search for a group GA contained in the search region to be paired with the subject group GB. Alternatively, the pair former 106 may determine a search region with respect to each of the groups GA and GB, and search for a group GB contained in the search region determined with respect to the group GA and a group GA contained in the search region determined with respect to the group GB. The pair former 106 may then integrate the two pairing results so as to determine a pair of groups corresponding to the same target object.

In the first embodiment, two radar devices A and B are used. However, three or more radar devices may be used.

### Second Embodiment

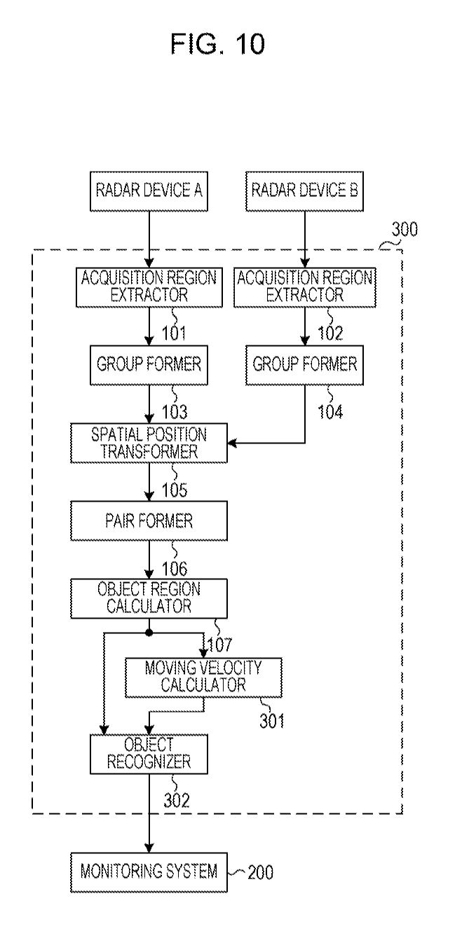

FIG. 10 is a block diagram illustrating the major configuration of an object detecting device 300 according to a second embodiment and the connection relationship of the object detecting device 300 to each of radar devices A and B and a monitoring system 200. In FIG. 10, the elements having the same configurations as those shown in FIG. 2 are designated by like reference numerals, and a detailed explanation thereof will thus be omitted. The object detecting device 300 is different from the object detecting device 100 of the first embodiment (FIG. 2) in that it includes a moving velocity calculator 301 and that an object recognizer 302 is operated differently from the object recognizer 108 of the object detecting device 100.

In the object detecting device 300, based on the object region calculated by the object region calculator 107, the moving velocity calculator 301 calculates all measurement values (such as distance, azimuth, reflection intensity, and Doppler value) corresponding to different plural positions on an object. The moving velocity calculator 301 determines the moving velocity of the object by utilizing all or some of the measurement values. That is, by using the measurement values of acquisition regions corresponding to the radar devices A and B and included in a target object region calculated by the object region calculator 107, the moving velocity calculator 301 calculates the moving velocity of the entire object corresponding to the target object region. If the target object is a vehicle, for example, the velocity is different between the vehicle body and the wheels of the vehicle. In the present disclosure, the velocity of the vehicle body is calculated as the moving velocity of the entire object.

Specifically, the moving velocity calculator 301 determines a quantity Vx in the x direction and a quantity Vy in the y direction of the object surface S (xy surface).

The measurement values obtained from the radar device A includes the azimuth θi, Doppler value Vs, and index i (i=1 through m) of the measurement values. The measurement values obtained from the radar device B includes the azimuth θi, Doppler value Vs, and index i (i=m+1 through m+n) of the measurement values. The m+n measurement values correspond to different reflecting points of the same target object T. The actual velocity (Vx, Vy) is found from equation (1):

$$[ \begin{matrix}{V}_{s , 1} \\ {V}_{s , 2} \\ ⋮ \\ {V}_{s , m + n}\end{matrix} ] = [ \begin{matrix}cos ( {θ}_{1} ) & sin ( {θ}_{1} ) \\ cos ( {θ}_{2} ) & sin ( {θ}_{2} ) \\ ⋮ & ⋮ \\ cos ( {θ}_{m + n} ) & sin ( {θ}_{m + n} )\end{matrix} ] [ \begin{matrix}{V}_{x} \\ {V}_{y}\end{matrix} ] \qquad ( 1 )$$

where Vx is the velocity in the x-axis direction and Vy is the velocity in the y-axis direction of the target object T on the xy surface. Concerning equation (1), see Florian Folster and Hermann Rohling, Lateral velocity estimation based on automotive radar sensors, International Conference on Radar 2006.

The object recognizer 302 determines the position, size, configuration, and type (for example, large-size four-wheeled vehicle, small-size four-wheeled vehicle, two-wheeled vehicle, or pedestrian) of the target object T, based on the features of the moving velocity of the target object T calculated by the moving velocity calculator 301, in addition to the features of the object region calculated by the object region calculator 107.

As described above, in the second embodiment, the object detecting device 300 calculates, not only the object region of the target object T, but also the moving velocity on the xy surface of the target object T. Then, the object detecting device 300 performs recognition processing for the target object T, based on the object region and the moving velocity. This makes it possible for the object detecting device 300 to enhance the precision in recognizing objects and the capability to detect the movement of objects. In the second embodiment, since the object detecting device 300 performs object recognition processing by utilizing plural measurement values on an object, it is able to calculate the velocity of the entire object more precisely by reducing the errors of measurement values than the object detecting device disclosed in Japanese Unexamined Patent Application Publication No. 2009-41981.

### Third Embodiment

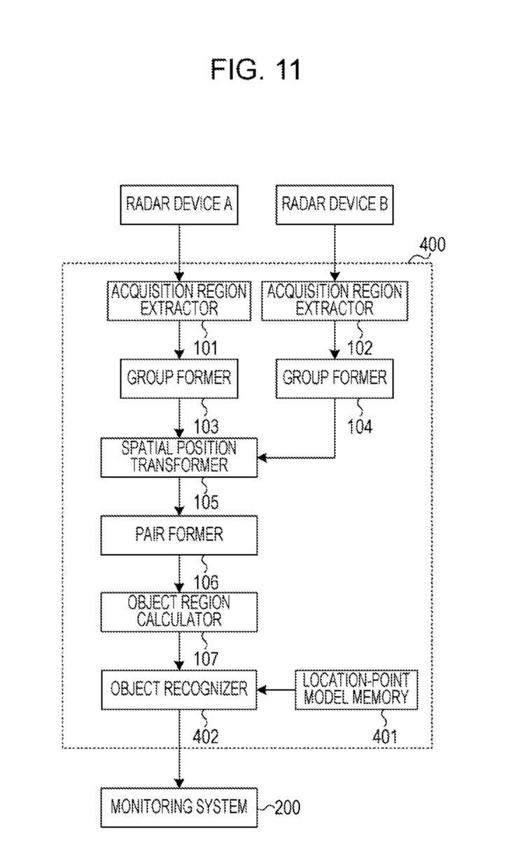

FIG. 11 is a block diagram illustrating the major configuration of an object detecting device 400 according to a third embodiment and the connection relationship of the object detecting device 400 to each of radar devices A and B and a monitoring system 200. In FIG. 11, the elements having the same configurations as those shown in FIG. 2 are designated by like reference numerals, and a detailed explanation thereof will thus be omitted. The object detecting device 400 is different from the object detecting device 100 of the first embodiment (FIG. 2) in that it includes a location-point model memory 401 and that an object recognizer 402 is operated differently from the object recognizer 108 of the object detecting device 100.

In the object detecting device 400, the location-point model memory 401 stores therein a location-point model in which features of a target object are represented as a model for each of the points of a detection range (for example, an intersection) of each radar device. More specifically, features (such as the size, configuration, and reflection intensity) of a target object are different according to the moving direction of the target object, and such features are represented as a location-point model for one or more points on reference coordinates. The location-point model memory 401 stores therein such location-point models in advance.

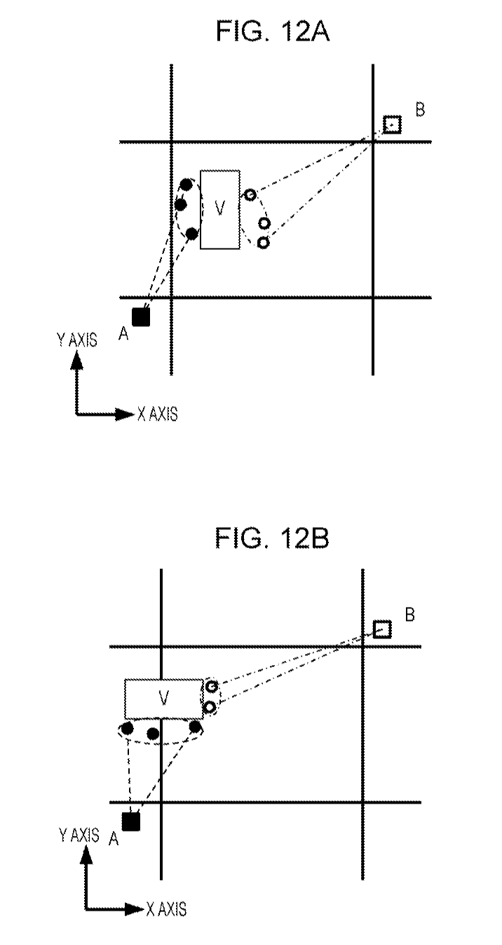

FIGS. 12A and 12B illustrate examples of the features of a mid-size vehicle V measured by the radar devices A and B at a certain location point on reference coordinates. FIG. 12A illustrates a state at a certain location point in which the mid-size vehicle V is traveling in the Y-axis direction, while FIG. 12B illustrates a state at the same location point as that in FIG. 12A in which the mid-size vehicle V is traveling in the X-axis direction. When the mid-size vehicle V is located at the same location point in FIGS. 12A and 12B, the value measured by the radar device A in the state in FIG. 12A is different from that in FIG. 12B. Similarly, when the mid-size vehicle V is located at the same location point in FIGS. 12A and 12B, the value measured by the radar device B in the state in FIG. 12A is different from that in FIG. 12B. That is, even if a target object (mid-size vehicle V) is located at the same location point, the features measured by a certain radar device are different according to the moving direction of the target object. The location-point model memory 401 obtains and stores a location-point model in advance in which the features of a target object that are different according to the moving direction of the target object are represented as a model for each of plural location points.

Location-point models stored in the location-point model memory 401 are not restricted to a specific target object (for example, a mid-size vehicle). The location-point model memory 401 may store location-point models for various types of target objects (for example, large-size vehicles, mid-size vehicles, small-size vehicles, two-wheeled vehicles, and pedestrians).

Based on the position of the center point of an object region and the orientation thereof calculated by the object region calculator 107, the object recognizer 402 specifies a location point of the object region. Then, the object recognizer 402 checks the features of the object region calculated by the object region calculator 107 against the location-point model corresponding to the location point of the object region so as to determine the features (position, size, configuration, and type) of the target object T.

In the third embodiment, the object detecting device 400 obtains location-point models in, a detection range of each of the radar devices A and B in advance, and checks the features of a detected object region against a corresponding location-point model so as to determine the features of the target object. Thus, the object detecting device 400 is able to perform recognition processing with high precision in accordance with the assumed state of an object at a certain point.

The third embodiment has been described as an extension of the first embodiment. However, the third embodiment may be combined with the second embodiment.

### Fourth Embodiment

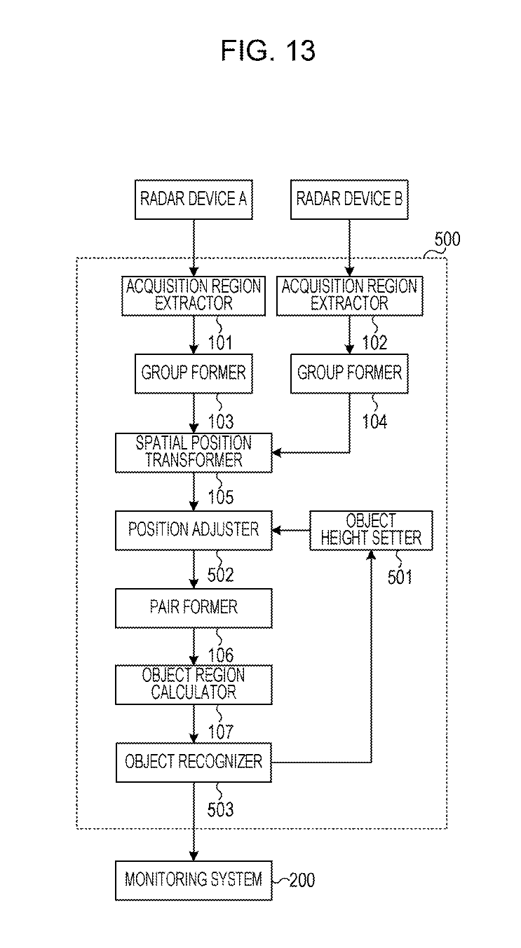

FIG. 13 is a block diagram illustrating the major configuration of an object detecting device 500 according to a fourth embodiment and the connection relationship of the object detecting device 500 to each of radar devices A and B and a monitoring system 200. In FIG. 13, the elements having the same configurations as those shown in FIG. 2 are designated by like reference numerals, and a detailed explanation thereof will thus be omitted. The object detecting device 500 is different from the object detecting device 100 of the first embodiment (FIG. 2) in that it includes an object height setter 501 and a position adjuster 502 and that an object recognizer 503 is operated differently from the object recognizer 108 of the object detecting device 100.

The radar devices A and B do not have a function of measuring the height.

In the object detecting device 500, the object height setter 501 sets provisional values for the height (hereinafter may also be called the “set height”) for acquisition regions corresponding to each of the radar devices A and B. For example, the object height setter 501 may set, as the set height, plural candidate values obtained by equally dividing a range of possible heights of target objects to be detected by the object detecting device 500.

Alternatively, if the type of target object is restricted, the object height setter 501 may set plural candidate values according to the type of target object as the set height. The object height setter 501 specifies the type of target object, based on the recognition result (type of object) obtained by the object recognizer 503 at a default height.

On the basis of the height set by the object height setter 501, from the measurement value (distance) of a group including acquisition regions output from the spatial position transformer 105, the position adjuster 502 calculates the ground position (that is, the position at which the height is 0) of this group.

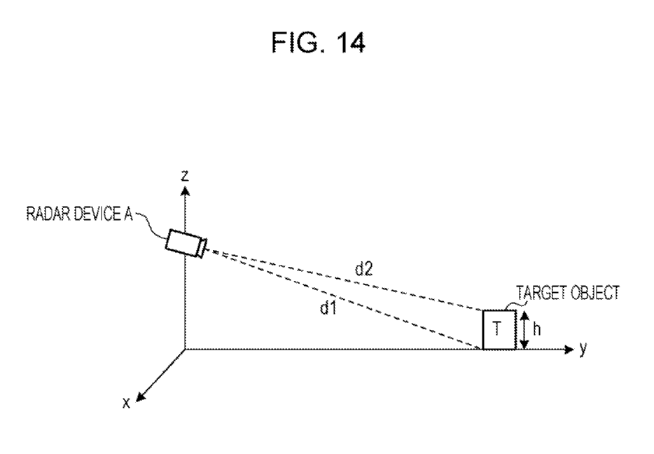

FIG. 14 illustrates the relationship between the measurement values of the radar device A and the height of a target object T. In FIG. 14, distances d1 and d2 measured by the radar device A for the target object T are shown. The distance d1 corresponds to the height 0, while the distance d2 corresponds to the height h. In FIG. 14, the distance d2 corresponding to the higher height (height=h) is smaller than the distance d1 corresponding to the lower height (height=0) (that is, d2<d1).

The height of a target object T is unknown to a radar device without a function of measuring the height. Accordingly, the true value of the height of the target object T corresponding to the distance measured by the radar device is unknown. If the height corresponding to the distance measured by the radar device is set as different provisional values, the ground position of the target object estimated from the distance measured by the radar device varies according to the provisional height. For example, if it is assumed that d2<d1, the distance measured by a radar device without a function of measuring the height is d2, and the height corresponding to the distance d2 is h, the position corresponding to the distance d1 measured by the radar device is calculated as the ground position corresponding to the distance d2 (height=h). On the other hand, if it is assumed that d2<d1, the distance measured by a radar device without a function of measuring the height is d2, and the height corresponding to the distance d2 is 0 (such a case is not shown), the position corresponding to the distance d2 measured by the radar device is calculated as the ground position. Accordingly, the target object is closer to the radar device than in a case in which the position corresponding to the distance d1 is calculated as the ground position.

In this manner, the position adjuster 502 calculates (adjusts) the ground position of each group of acquisition regions in accordance with the height set by the object height setter 501. That is, in the object detecting device 500, the elements subsequent to the position adjuster 502 perform processing by using the measured distance of each group based on the adjusted ground position. In the object detecting device 500 shown in FIG. 13, the position adjuster 502, the pair former 106, the object region calculator 107, and the object recognizer 503 repeatedly perform object detecting processing for the plural candidates as the height set by the object height setter 501.

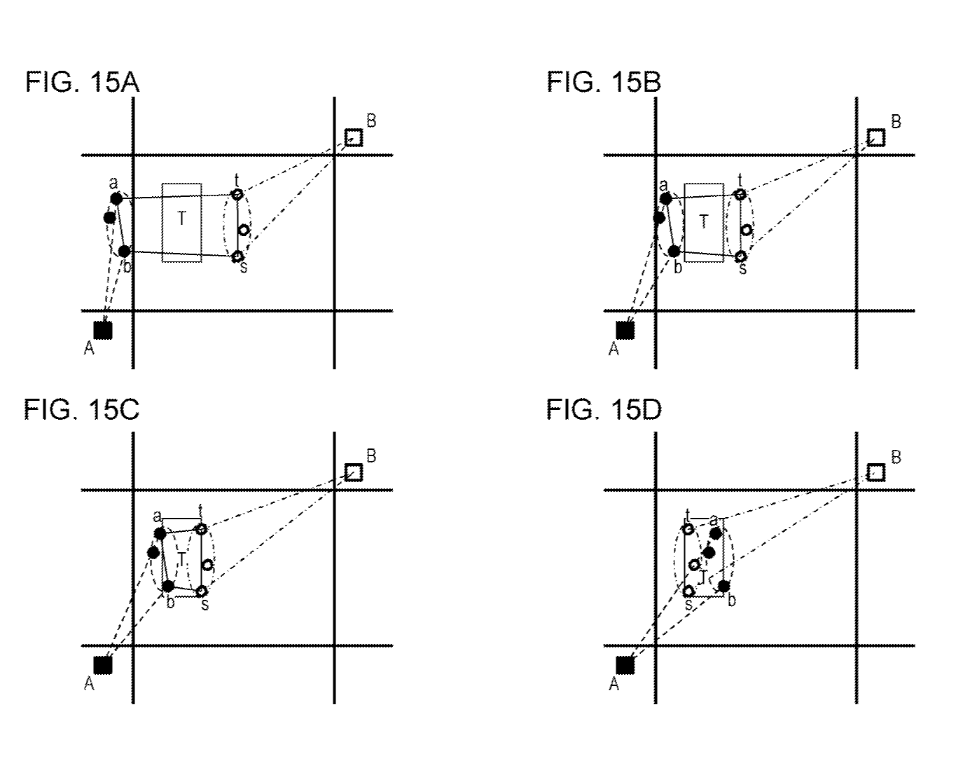

FIGS. 15A through 15D illustrate examples of the ground position of the object region abst calculated by the object region calculator 107 when plural candidates are set as the height by the object height setter 501.

FIGS. 15A through 15D illustrate the positions of the groups including acquisition regions calculated by the position adjuster 502 in a case in which the height corresponding to the measured value is assumed as 0, h1, h2, and h3, respectively, (0<h1<h2<h3). The position of the target object T shown in FIGS. 15A through 15D is the actual ground position. In FIGS. 15A through 15D, the true value of the height corresponding to the measured value is assumed as h2 (FIG. 15C).

In FIG. 15A (set height: 0), the positions of the groups including the acquisition regions calculated by the position adjuster 502 are estimated to be closer to the radar devices A and B than the actual positions of the target object T. Accordingly, in FIG. 15A, the area of the object region abst calculated by the object region calculator 107 is larger than the actual area of the target object T.

In FIG. 15B, the set height h1 is slightly lower than the actual height h2. The positions of the groups including the acquisition regions calculated by the position adjuster 502 are estimated to be closer to the radar devices A and B than the actual positions of the target object T. Accordingly, in FIG. 15B, the area of the object region abst calculated by the object region calculator 107 is slightly larger than the actual area of the target object T, though it is smaller than the area of the object region abst shown in FIG. 15A.

In FIG. 15C, the set height h2 is the same as the actual height of the target object corresponding to the measured value. The positions of the groups including the acquisition regions calculated by the position adjuster 502 are substantially the same as the actual positions of the target object T. Accordingly, in FIG. 15C, the area of the object region abst calculated by the object region calculator 107 is substantially the same as the actual area of the target object T.

In FIG. 15D, the set height h3 is much higher than the actual height h2. The positions of the groups including the acquisition regions calculated by the position adjuster 502 are estimated to be farther from the radar devices A and B than the actual positions of the target object T. The positional relationship between the points a and b measured by the radar device A and the points s and t measured by the radar device B is reversed. Accordingly, the maximum value of the set height is restricted to a suitable range which does not reverse the positional relationship between the points a and b and the points s and t.

As shown in FIGS. 15A through 15D, as the height h is set to be higher, the position of the group of the acquisition regions detected by the radar device A and that by the radar device B are approaching each other, and the area of the object region calculated by the object region calculator 107 is becoming smaller. However, if the height h is set to be excessively high, the positional relationship between the group of the acquisition regions detected by the radar device A and that detected by the radar device B is reversed.

The object recognizer 503 retains a typical value of the area of a target object T at the ground position according to the type (for example, vehicles, motorcycles, bicycles, or pedestrians) of target object T. As the typical value, the ratio of the area of each type of target object at the ground position to the height of the target object may be used.

By using the values of plural candidates set as the height by the object height setter 501 and the values of the areas of the target object regions calculated by the object region calculator 107, the object recognizer 503 calculates values (for example, the ratio of the area of the target object region at the ground position to the height of the target object) corresponding to the retained typical value.

The object recognizer 503 compares the calculated values with the retained typical value of the target object. The object recognizer 503 then selects the calculated value representing an area contained within a specified range and closest to the typical value of the target object, and determines the set height (set height h2 in FIG. 15C among the heights 0, h1, h2, and h3 shown in FIGS. 15A through 15D) corresponding to the selected value as the actual height of the target object. In this manner, the object recognizer 503 determines the area of the target object region and the height of the target object.

As described above, in the fourth embodiment, the object detecting device 500 includes the object height setter 501 and the position adjuster 502. The object height setter 501 sets candidate values of the height of a target object for acquisition regions included in plural groups corresponding to the radar device A and those corresponding to the radar device B. The position adjuster 502 estimates the position of each of the acquisition regions at the ground position in accordance with each of the candidates set as the height. The object region calculator 107 calculates target object regions at the ground position. The object recognizer 503 retains a typical value concerning the area at the ground position for each of plural target object candidates. The object recognizer 503 then compares the values of the areas of the target object regions calculated for the candidate values of the height with the typical value. The object recognizer 503 then selects the calculated value of the area closest to the typical value and sets the height corresponding to the selected value to be the height of the target object.

In the fourth embodiment, even if a radar device does not have a function of measuring the height of a target object, the object detecting device 500 is able to estimate the height of the target object and also to estimate the target object region with high precision. The fourth embodiment is effective when the values measured by a radar device vary according to the height of an object.

In the above-described embodiments, an aspect of the present disclosure is constituted by hardware. However, the present disclosure may be implemented by software in cooperation with hardware.

The functional blocks utilized for describing the above-described embodiments are implemented typically by a large scale integrated circuit (LSI), which is one example of integrated circuits. The integrated circuit may control the functional blocks in the above-described embodiments and may include an input terminal and an output terminal. These functional blocks may be formed into individual chips, or some or all of the functional blocks may be formed into one chip. Such an LSI may be called an IC, a system LSI, a super LSI, or an ultra LSI, depending on the integration degree.

The integration technology of the functional blocks is not restricted to an LSI technology. Instead, a dedicated circuit or a general-purpose processor may be used. For example, a field programmable gate array (FPGA) that is programmable after it is manufactured, or a reconfigurable processor that may reconfigure connections or settings of circuit cells within this processor may be used.

Further, due to the progress of semiconductor technologies or the appearance of a derivative technology, if a circuit integration technology which replaces an LSI technology is developed, the functional blocks may be integrated by utilizing such a technology. The application of a biotechnology, for example, may be one of such cases.

### (Conclusions of the Present Disclosure)

According to a first aspect of the present disclosure, there is provided an object detecting device including first acquisition region extraction circuitry, which in operation, extracts one or more first acquisition regions from among a plurality of first unit regions corresponding to a first radar device, each of one or more target objects being likely to be located in each of the one or more first acquisition regions; second acquisition region extraction circuitry, which in operation, extracts one or more second acquisition regions from among a plurality of second unit regions corresponding to a second radar device, each of the one or more target objects being likely to be located in each of the one or more second acquisition regions; first group formation circuitry, which in operation, forms one or more first groups each including each of the one or more first acquisition regions;

second group formation circuitry, which in operation, forms one or more second groups each including each of the one or more second acquisition regions; pair formation circuitry, which in operation, forms one or more pairs of each of the one or more first group and an associated second group selected as one or more pairing target groups by selecting from among the one or more second groups, on a coordinate system including the one or more first groups, the one or more second groups, and the first and second radar devices, on the basis of a position of the first radar device, a position of the second radar device, and a size of a corresponding first group of the one or more first groups; object region calculation circuitry, which in operation, calculates, on the coordinate system, one or more target object regions for each of the one or more pairs; and object recognition circuitry, which in operation, recognizes, on the coordinate system, each of the one or more target objects based on each of the one or more target object regions.

According to a second aspect of the present disclosure, in the object detecting device according to the first aspect, the pair formation circuitry calculates, based on the first radar device, a first line segment representing a size of each of the one or more first groups; the pair formation circuitry sets a search region between a midpoint of the first line segment and the second radar device; and the pair formation circuitry selects a second group which at least overlaps the search region from among the one or more second groups as the one or more pairing target groups.

According to a third aspect of the present disclosure, he object detecting device according to the first aspect may include moving velocity calculation circuitry, which in operation, calculates a velocity of each one or more target object regions calculated by the object region calculator by using a measurement value of the one or more first acquisition regions and a measurement value of the one or more second acquisition regions included in a corresponding target object region, wherein the object recognition circuitry recognizes each of the one or more target objects, on the basis of a corresponding target object region and the moving velocity of the corresponding target object region.

According to a fourth aspect of the present disclosure, the object detecting device according to the first aspect include location-point model memory circuitry, which in operation, stores therein in advance a location-point model which represents a feature of the one or more target objects detected by the first and second radar devices at one or more location points of the coordinate system, wherein the object recognition circuitry recognizes a type of each of the one or more target objects by checking a feature of a corresponding target object region against the location-point model.

According to a fifth aspect of the present disclosure, object height setting circuitry, which in operation, sets candidate values of a height of each of the one or more target objects for the one or more first acquisition regions included in the one or more first groups and for the one or more second acquisition regions included in the one or more second groups; and position adjusting circuitry, which in operation, estimates one or more positions of the one or more first acquisition regions included in the one or more first groups on the coordinate system and one or more positions of the one or more second acquisition regions included in the one or more second groups on the coordinate system, in accordance with each of the set candidate values of the height of each of the one or more target objects, wherein the object region calculation circuitry calculates one or more positions of each of one or more the target object regions on the coordinate system by using the estimated one or more positions of each of the one or more first acquisition regions on the coordinate system and the one or more estimated positions of each of the one or more second acquisition regions on the coordinate system, the object recognition circuitry retains in advance a first value concerning an area of each of the one or more target objects at a position on the coordinate system, and the object recognition circuitry calculates the area of the target object region in accordance with each of the candidate values of the height of each of the one or more target objects, selects a calculated area closest to the first value among the calculated areas of each of the one or more target object regions, and determines a height of each of the one or more target objects having the selected calculated area to be the height of each of the one or more target objects.

According to a sixth aspect of the present disclosure, there is provided an object detecting method including: extracting one or more first acquisition regions from among a plurality of first unit regions corresponding to a first radar device, each of one or more target objects being likely to be located in each of the one or more first acquisition regions; extracting one or more second acquisition regions from among a plurality of second unit regions corresponding to a second radar device, each of the one or more target object being likely to be located in each of the one or more second acquisition region; forming one or more first groups each including each of the one or more first acquisition regions; forming one or more second groups each including each of the one or more second acquisition regions; forming one or more pairs of each of the one or more first groups and an associated second group selected as one or more pairing target groups by selecting from among the one or more second groups, on a coordinate system including the one or more first groups, the one or more second groups, and the first and second radar devices, on the basis of a position of the first radar device, a position of the second radar device, and a size of a corresponding first group of the one or more first groups; calculating, on the coordinate system, one or more target object regions for each of one or more pairs; and recognizing, on the coordinate system, each of the one or more target objects based on each of the one or more target object regions.

The present disclosure is suitably used in a road infrastructure system. In the case of the application to a road infrastructure system, four-wheeled vehicles, two-wheeled vehicles, and pedestrians on the road or at the intersection can be detected, thereby making it possible to monitor the traffic situation, control the road infrastructure system, and supply information to the drivers. As a result, traffic management can be performed and traffic accidents can be prevented.

What is claimed is:

1. An object detecting device comprising:
first acquisition region extraction circuitry, which in operation, extracts one or more first acquisition regions from among a plurality of first unit regions corresponding to a first radar device, each of one or more target objects being likely to be located in each of the one or more first acquisition regions;
second acquisition region extraction circuitry, which in operation, extracts one or more second acquisition regions from among a plurality of second unit regions corresponding to a second radar device, each of the one or more target objects being likely to be located in each of the one or more second acquisition regions;
first group formation circuitry, which in operation, forms one or more first groups each including each of the one or more first acquisition regions;
second group formation circuitry, which in operation, forms one or more second groups each including each of the one or more second acquisition regions;
pair formation circuitry, which in operation, forms one or more pairs of each of the one or more first group and an associated second group selected as one or more pairing target groups by selecting from among the one or more second groups, on a coordinate system including the one or more first groups, the one or more second groups, and the first and second radar devices, on the basis of a position of the first radar device, a position of the second radar device, and a size of a corresponding first group of the one or more first groups;
object region calculation circuitry, which in operation, calculates, on the coordinate system, one or more target object regions for each of the one or more pairs; and
object recognition circuitry, which in operation, recognizes, on the coordinate system, each of the one or more target objects based on each of the one or more target object regions.

2. The object detecting device according to claim 1, wherein:
the pair formation circuitry calculates, based on the first radar device, a first line segment representing a size of each of the one or more first groups;
the pair formation circuitry sets a search region between a midpoint of the first line segment and the second radar device; and
the pair formation circuitry selects a second group which at least overlaps the search region from among the one or more second groups as the one or more pairing target groups.

3. The object detecting device according to claim 1, comprising:
moving velocity calculation circuitry, which in operation, calculates a velocity of each one or more target object regions calculated by the object region calculator by using a measurement value of the one or more first acquisition regions and a measurement value of the one or more second acquisition regions included in a corresponding target object region,
wherein the object recognition circuitry recognizes each of the one or more target objects, on the basis of a corresponding target object region and the moving velocity of the corresponding target object region.

4. The object detecting device according to claim 1, comprising:
location-point model memory circuitry, which in operation, stores therein in advance a location-point model which represents a feature of the one or more target objects detected by the first and second radar devices at one or more location points of the coordinate system,
wherein the object recognition circuitry recognizes a type of each of the one or more target objects by checking a feature of a corresponding target object region against the location-point model.

5. The object detecting device according to claim 1, comprising:
object height setting circuitry, which in operation, sets candidate values of a height of each of the one or more target objects for the one or more first acquisition regions included in the one or more first groups and for the one or more second acquisition regions included in the one or more second groups; and
position adjusting circuitry, which in operation, estimates one or more positions of the one or more first acquisition regions included in the one or more first groups on the coordinate system and one or more positions of the one or more second acquisition regions included in the one or more second groups on the coordinate system, in accordance with each of the set candidate values of the height of each of the one or more targets, wherein
the object region calculation circuitry calculates one or more positions of each of one or more the target object regions on the coordinate system by using the estimated one or more positions of each of the one or more first acquisition regions on the coordinate system and the one or more estimated positions of each of the one or more second acquisition regions on the coordinate system,
the object recognition circuitry retains in advance a first value concerning an area of each of the one or more target objects at a position on the coordinate system, and
the object recognition circuitry calculates the area of the target object region in accordance with each of the candidate values of the height of each of the one or more target objects, selects a calculated area closest to the first value among the calculated areas of each of the one or more target object regions, and determines a height of each of the one or more target objects having the selected calculated area to be the height of each of the one or more target objects.

6. An object detecting method comprising:
extracting one or more first acquisition regions from among a plurality of first unit regions corresponding to a first radar device, each of one or more target objects being likely to be located in each of the one or more first acquisition regions;
extracting one or more second acquisition regions from among a plurality of second unit regions corresponding to a second radar device, each of the one or more target object being likely to be located in each of the one or more second acquisition region;
forming one or more first groups each including each of the one or more first acquisition regions;
forming one or more second groups each including each of the one or ore second acquisition regions;
forming one or more pairs of each of the one or more first groups and an associated second group selected as one or more pairing target groups by selecting from among the one or more second groups, on a coordinate system including the one or more first groups, the one or more second groups, and the first and second radar devices, on the basis of a position of the first radar device, a position of the second radar device, and a size of a corresponding first group of the one or more first groups;
calculating, on the coordinate system, one or more target object regions for each of one or more pairs; and
recognizing, on the coordinate system, each of the one or more target objects based on each of the one or more target object regions.
